(19) United States
(12) Patent Application Publication
(10) Pub. No.: US 2010/0042422 A1
(43) Pub. Date: Feb. 18, 2010

(54) System and method for computing and displaying a score with an associated visual quality indicator

(76) Inventor: Adam Summers, Glen Burnie, MD (US)

Correspondence Address: CLIFFORD H. KRAFT, 320 ROBIN HILL DR., NAPERVILLE, IL, 60540, US

(21) Appl. No.: 12/228,876

(22) Filed: Aug. 15, 2008

(51) Int. Cl. G06Q 99/00

(52) U.S. Cl. 705/1

(57) ABSTRACT

A system and method for computing and outputting a score or rating with an associated visual quality indicator. The score or rating can be the result of a survey or come from any other source. The visual indicator representing the quality of the score or rating can include a series of different colors, icons or a series of multiple icons. The quality can also be displayed as written text. Ratings may be supplied that have been processed by others (for example those who took a particular survey), or they may be supplied as raw data. The invention can output the score or rating and its associated indicator as to the quality of the score or rating either integral to the score or rating or near the score or rating. When raw data is supplied, the present invention can reduce that data using any type of mathematical or statistical technique, and then output the reduced rating values along with associated qualities on a display device or printed material.

### BACKGROUND

1. Field of the Invention

The present invention relates generally to the field of computing and generating output in the form of a display or printed material and more particularly to a system and method of computing and displaying a score with an associated visual indicator on a display device or printed material.

2. Description of the Prior Art

A variety of grading or scoring systems are commonly used throughout numerous industries to describe the quality of a particular person, place, product, service or event. Also, there are numerous scales and ways to grade. For example, one survey might result in an overall rating of 8 on a scale of 1-10 for some product. A different survey might result in an overall rating or score of “B+” on a scale of “F” to “A+”. In order to determine a rating or score, raters typically sample the product and then answer survey questions concerning multiple criteria. An overall score could be calculated based on the average of the individual responses.

For example, a survey evaluating a hand cream might require a numerical answer to a group of questions where there is a scale: 1=strongly disagree, . . . 5=agree, . . . 10=strongly agree. The questions might then be a series of statements:
1. The cream absorbs well.
2. The cream smells good.
3. The bottle is easy to use.
4. The presentation of the bottle and label are overall very attractive.
5. The directions are clear on how to use the cream.
6. The price is favorable.
7. . . .
   A particular rater might answer: 1=10, 2=5, 3=2, 4=7, 5=1, 6=7,

In order to get an overall score for this particular rater, an average might be used. In this case, the average is (10+5+2+7+1+7)/7=4 4/7. There are numerous other ways to generate overall ratings. In some cases, particular questions might be weighted more than others. When scores are tallied, the manufacturer can decide if the product has enough market appeal, and potential users can make a decision as to whether the product is something they would be interested in using or purchasing.

Unfortunately, there are a number of issues surrounding the reporting of these scores or ratings that reduces their reliability including rater biases and rater sample sizes. A skew in the characteristics of the raters can seriously affect the ratings. In the example of the hand cream, women raters might care much more than men how the product smells than men. People with a particular type of skin or complexion might care more about how the cream is absorbed than others. Another serious danger in any rating system of this type is when the sample size is too small. For example, if 10 raters give a product an “A” in a first survey, and 1000 raters give the product an “A” in second survey, the “A” grade from the second survey means more than that from the first survey simply because the probability of a large sample group all voting the same way randomly is very small, and thus a large positive vote is a good indication for the product. As an example of this, if there are 2 choices, the probability of a rater choosing one of them randomly is 0.5. The probability of 10 raters choosing the same number randomly is (0.5)¹⁰=0.000976, while the probability of 1000 raters choosing the same number randomly is (0.5)¹⁰⁰⁰=(a very, very, very small number). Thus, the larger the sample size, the more reliable the results are. Also, in general, the more diverse the sample is, the less chance of rater bias.

There are also possible problems with ratings. A rater who desires to negatively or positively influence the overall results could hypothetically enter multiple low or high ratings in an attempt to skew the results. Similarly, a product or service with a low number of very high or very low ratings would have a very high or very low average which might not reflect a more accurate rating achieved with a possibly larger sample size.

It would be very advantageous to have a system and method for not only displaying rating scores, but also one that simultaneously indicates the quality of the particular score. Such a system could display a quality indicator alongside or as a part of the displayed score.

U.S. Pat. No. 7,003,503 teaches a method of ranking items and displaying a search result based on weights chosen by the user. U.S. Pat. No. 6,944,816 allows entry of criteria to be used in analysis of candidates, the relative importance value between each of the criteria, and raw scores for the criteria. The results are computed and placed in a spreadsheet. U.S. Pat. No. 6,155,839 provides for displaying test questions and answers as well as rules for scoring the displayed answer. U.S. Pat. No. 6,772,019 teaches performing trade-off studies using multi-parameter choice. Choice criteria are weighted using pair-wise comparisons to minimize judgment errors. Results can be made available to an operator in formats selectable by the operator. U.S. Pat. No. 6,529,892 generates a confusability score among drug names using similarity scores. None of the prior art teaches a system and method for displaying the quality of a score by adding a visual indicator to a rating to provide an individual viewing the rating a better understanding of the significance of the rating.

### SUMMARY OF THE INVENTION

The present invention relates to a system and method for computing and displaying a score with an associated visual quality indicator. When the visual indicator is associated with, either integral to or in proximity with the score or rating, the score or rating can be referred to as a “qualified score” or a “qualified rating”. The visual indicator associated with or integral to the score or rating, represents the quality of the displayed score or rating through the use of: (a) a color or series of different colors such as green, yellow, red; (b) icons such as thumbs up or thumbs down; (c) a series of multiple icons such as two thumbs up, one thumb down, etc. The visual quality indicator may also be text. Any type of quality indicator associated with or integral to a score or rating is within the scope of the present invention. Scores or ratings may be supplied into the present invention that have been processed by others (for example those who took a particular survey). In this case, the present invention can display the score or rating, and near it, or as a part of the score or rating, display the quality of the score or rating. In other cases, the present invention can be supplied with raw data from surveys or other sources, can reduce that data using any type of mathematical or statistical technique, and then display the reduced score or rating values along with associated qualities. In addition, the quality of the score or rating may be used to display the associated score or rating in some other format, such as in a sorted or filtered list of scores or ratings.

### DESCRIPTION OF THE DRAWINGS

Attention is now directed to the following drawings that are being provided illustrate the features of the present invention:

FIG. 1 shows a display of a set of scores or ratings using color to indicate quality.

FIG. 2 shows a display of a set of scores or ratings using a single icon to indicate quality.

FIG. 3 shows a display of a set of scores or ratings using multiple icons to indicate quality.

FIG. 4 is a block diagram depicting one method the present invention can use to determine quality.

Several drawings and illustrations have been presented to aid in understanding the present invention. The scope of the present invention is not limited to what is shown in the figures.

### DESCRIPTION OF THE INVENTION

The present invention is a system and method that allows computation of a quality measure for each score or rating in a set of scores or ratings and allows output (either on a display device or printed material) of the scores or ratings along with the quality measure in a way that a user can determine the overall weight or significance to attribute to a particular score or rating. The resulting quality measure may also be used by a user or a computation device to sort or filter a list of scores or ratings based on their quality measure, enabling the preferential display or output of those scores or ratings with a desired quality measure.

As previously discussed, surveys are regularly taken to assess people, places, events, products or services. In addition, numerous other scores or ratings are generated every day relating to people, places, events, products or services. A person may be a private individual, a professional, a public figure, or group of individuals, professionals or public figures. A place may be a physical location, a company, or an organization, A thing may be a product, device, equipment, food, beverage or any other tangible substance. A service may be provided by or to any person, place or thing.

An individual viewing these ratings has no way to determine exactly what the score or rating means. For example, if hand cream A had an overall rating of 85% and hand cream B only had a rating of 65%, the ratings are meaningless and possibly misleading if these scores were determined by different methods using different sample sizes or biases of raters or by many other factors. In contrast, if these two scores were displayed with the 65% rating having a related icon of 4 “thumbs up” symbols with the 85% rating having a “thumbs down” symbol, the user could immediately tell that the 85% score might be bogus or at least suspect. In this case, the user might determine that the product with the very solid 65% score really was the best choice.

The present invention includes different mechanisms to determine the quality of a score or rating and produce a quality measure. In producing this quality measure, the system can consider any information collected regarding how a score or rating was determined including how large the sample size was, any known bias in the sample, the recentness of the sample, mechanism of scoring, or individual(s) contributing to the score including information about the individual(s) providing the raw data such as their level of prior participation in surveys or attendance or purchases, their level of education, their IP (internet protocol) address, or a personal identifier such as their e-mail address, social security number, tax ID number or other unique identifier.

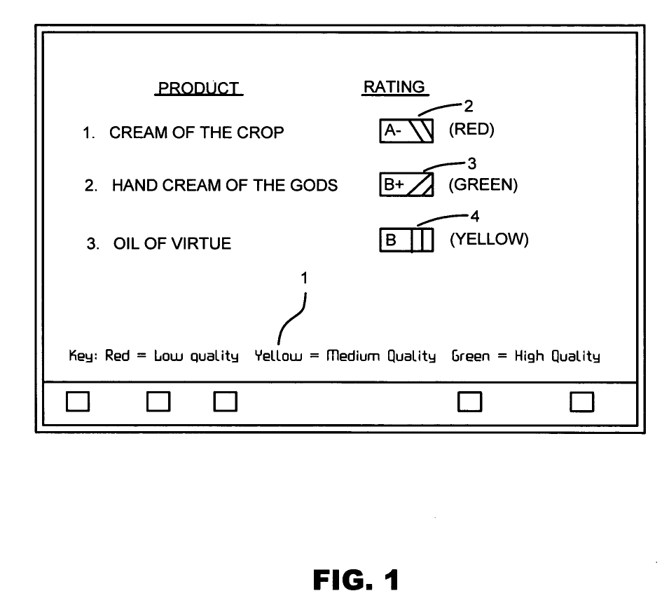

The collected information may come from the source of the ratings or raw data from surveys or other sources. The present invention may reduce collected data using various statistical methods, and generate final scores along with a quality factor for each score. After the ratings and qualities are determined, the system and method of the present invention can display the results. In one implementation of the present invention, the score or rating itself could be displayed in a color, thus integrating the quality indicator within or as a part of the original score or rating. For example, FIG. 1 shows the use of a computer screen to display a color to provide a quality measure. A key on the screen 1 shows that red=low reliability, yellow=medium reliability, and green=high reliability. While colors cannot be seen in FIG. 1, the “A−” score for the first product is displayed as red 2, the “B+” score for the second product is displayed as yellow 3, and the “B” score for the third product is displayed as green 4. This display indicates that the green “B” score for the third product is very reliable, while the yellow “B+” score for the first product may be suspect. Although the first product has a rating of “A−”, the user would know from the associated quality indicator (in this case, a red color) that the score for the first product is very unreliable. Based on the quality indicator, the output could be sorted or filtered at the user's request.

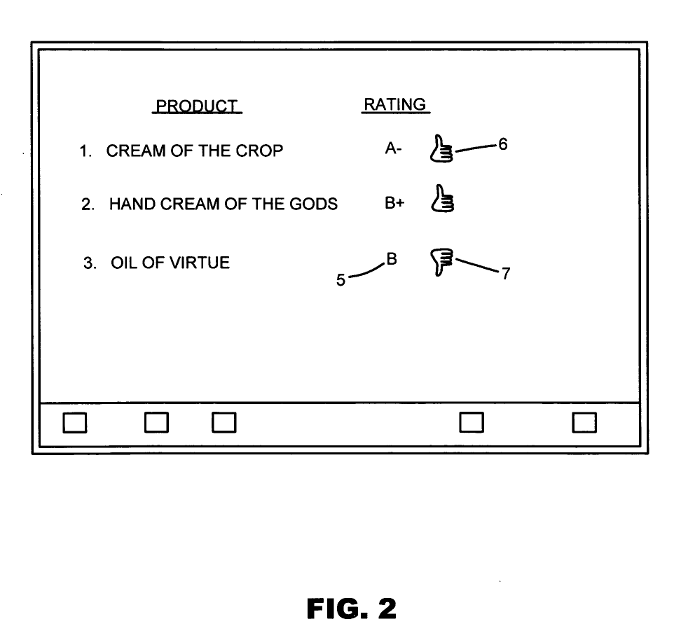

FIG. 2 shows a binary situation where the quality of the score 5 is shown by a single thumbs up 6 or a single thumbs down 7.

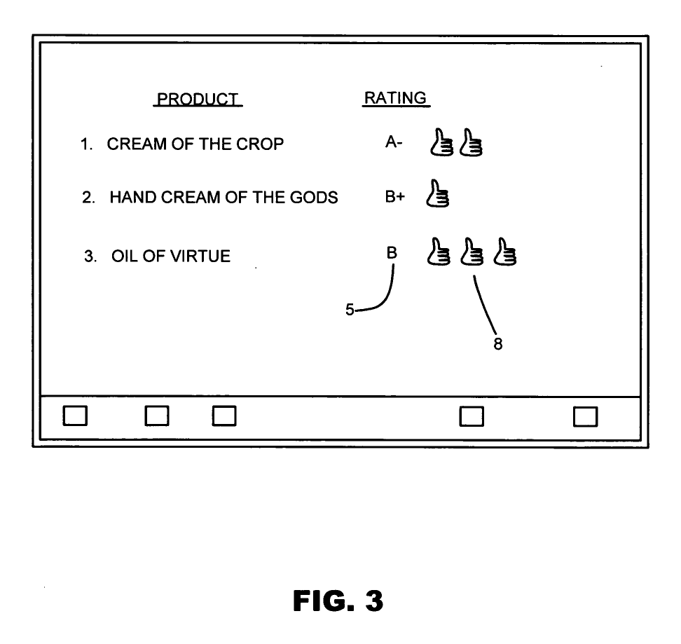

FIG. 3 shows a sliding scale using icons. The score 5 can get multiple thumbs up icons 8 such as one, two or more to give more resolution to the presentation of the quality measure than would be permitted by the limited binary model of FIG. 2. It should be noted that while the thumbs up or thumbs down icon has been used as an example, any indicator of quality whatsoever or any quality icon or icons are within the scope of the present invention.

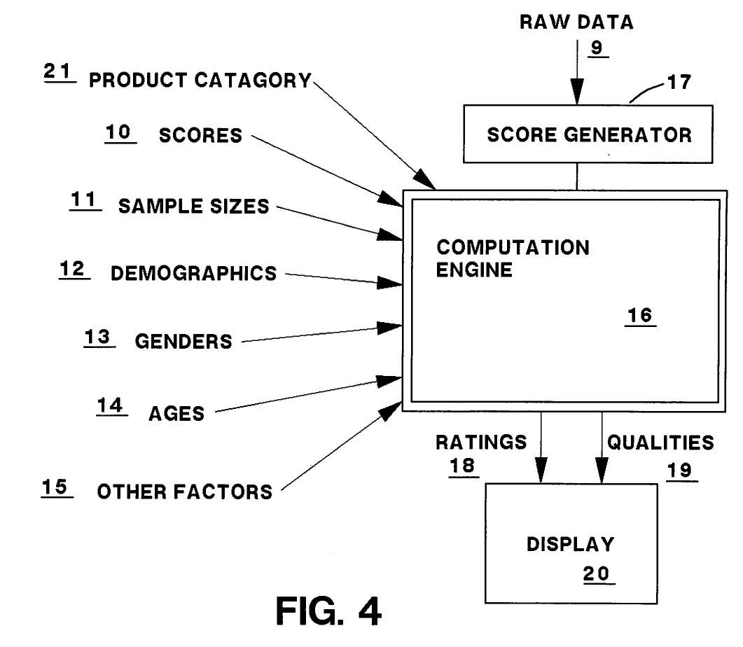

FIG. 4 shows a flow chart of an embodiment of the present invention where raw data 9 or finished scores 10 as well information on how the scores or data was determined such as product category 21, sample sizes 11, demographics 12, sample gender composition 13, rater's age groups 14, and other quality determining factors 15 are fed into a quality computing engine 16. Raw data 9 can be fed into a score generator 17. The rating results 18 as well as quality measures 19 can be displayed for a user on a display 20 as visual quality indicators such as colors or icons, as described, or in any other form.

The system can allow a user or rater to select which items or questions are most important and thereby rank-order or weight each item. The inputs from all users or raters for each question can be averaged, and then the average weight of each question can be used in a formula for computing the quality of the overall rating. The total number of ratings provided for each item can play a role in the calculation of the quality.

Using SURVEY dependent variables and RATER dependent variables, the quality of a single rating/score or a group of ratings/scores can be determined using various formula.

### Survey Dependent Variables:

Subject=person/place/thing/event
R_{Avg}=average rating of all completed questions for a single Survey
Completed=the number of questions in the Survey completed by the Rater
Q_{Total}=the total number of questions in the Survey
S_{Total}=the total number of Surveys for a given Subject
S_{Avg}=the average number of Surveys completed per Subject

### Rater Dependent Variables:

Verified=the Rater's identity has been verified or the Rater is anonymous (−2=anonymous, 1=verified)
Unique=the Rater has completed the Subject survey once (−2=not unique, 1=unique)
Prior=the number of surveys previously completed by the Rater on different Subjects

RaterQuality=Unique+Verified+(Prior>0)

The above RaterQuality formula combines multiple criteria about a Rater. For example, if the Rater has completed prior surveys on different Subjects, the Rater is considered to be more reliable and the RaterQuality is increased by a factor of “1”. If the Rater has completed the survey more than one time (e.g. the Rater is attempting to skew the average result), the RaterQuality is decreased by a factor of “2”. If the Rater is not anonymous, the RaterQuality is increased by a factor of “1”, otherwise it is reduced by a factor of “2”. Because there are dynamic components to the RaterQuality in this example, it is possible that the RaterQuality can be changed over time.

Using the above variables, if multiple Subjects are rated/scored based on multiple criteria by multiple raters, then a determination can be made about the Quality (Q) of: (a) the rating/score of each question/criteria; (b) the overall rating/score of a completed survey (based on, for example, the average or weighted average of all questions/criteria in the survey); or (c) the rating/score of a Subject based on all completed surveys regarding the Subject.

The Quality (Q) will be influenced by the ratings/scores themselves as well as information about the Rater (RaterQuality). Calculation of the Quality (Q) may be a static process (once the Quality has been determined, the Quality will not change if the survey is closed to new input by the Rater) or a dynamic process (the Quality may change if the survey is open to new input by the Rater or if new information is gathered about the Rater).

Once the Quality (Q) has been determined, a third party (an individual or computer system) could subsequently analyze a table of responses consisting of multiple Raters' qualified responses and decide, perhaps, to ignore responses codified as having a poor Quality.

### EXAMPLE FORMULAS

The following are provided as examples to illustrate aspects and features of the present invention. The scope of the present invention is not limited to what is shown in the following examples.

### A. Quality of a Single Criteria Rating of a Subject

The rating/score of any single question/criteria (R_{X}) about a Subject may be qualified, for example, based (1) on how the rating/score (R_{X}) compares to the average of all ratings/scores (R_{Avg}) in the Survey and (2) on information derived about the Rater (above). Other variables may be used in the equation to further evaluate the quality of a single criteria.

Quality(Q)=ABS((R_{X}−R_{Avg})<20)+RaterQuality

In the above example, if the individual rating/score (R_{X}) is more than 20% from the average of all ratings/scores in the survey, the Quality (Q) is reduced by a factor of “1”. The effect of this calculation, for example, is to reduce the weight of any rating/scoring outside of the standard bell-curve distribution of all ratings/scorings for this Survey.

Therefore, the Quality (Q) result will range from “−4” to “4”

| Calculated Quality | Assessment | Quality Indicator Example |
|---|---|---|
| Q < 0 | Poor | Rating/Score shown in red color or |
| | | with “thumbs down” icon |
| 0 < Q < 3 | Average | Rating/Score shown in |
| | | yellow color or with one “thumbs |
| | | up” icon |
| Q > 2 | Superior | Rating/Score shown in green |
| | | color or with two “thumbs up” icons |

### B. Quality of a Completed Survey

The overall rating/score of a Survey (a set of questions/criteria completed by one Rater) can be used to compare multiple Surveys. The overall rating/score of an individual Survey may be calculated from the multitude of responses to the questions/criteria in the Survey regarding a Subject as well as Rater specific information (above). In addition to Rater-based criteria (RaterQuality), in the following example, a completed Survey has a higher calculated Quality (Q) if more than 90% of the questions in the Survey were answered by the Rater. Other variables may be used in the equation to further evaluate the quality of a Survey.

Quality(Q)=ABS((Completed/Q_{Total})>90%)+RaterQuality

Therefore, the Quality (Q) of a given Survey will range from “−4” to “4”

| Calculated Quality | Assessment | Quality Indicator Example |
|---|---|---|
| Q < 0 | Poor | Rating/Score shown in red color or |
| | | with “thumbs down” icon |
| 0 < Q < 3 | Average | Rating/Score shown in |
| | | yellow color or with one “thumbs |
| | | up” icon |
| Q > 2 | Superior | Rating/Score shown in green |
| | | color or with two “thumbs up” icons |

### C. Quality of a Subject

The overall rating/score of a Subject can be used to compare multiple Subjects. The overall rating/score of each Subject may be calculated from multiple Surveys regarding each specific Subject. If many high-quality completed Surveys are available for a Subject, then the quality of the Subject may be inferred. In the following example, the number of completed Surveys for a Subject (S_{Total}) must be at least as good as the average number of Surveys (S_{Avg}) for all Subjects. Also, the average Quality (Q) of all Surveys for a Subject (e.g. the average of all Survey Quality assessments calculated in “B” above for a Subject) must be at a specified threshold. Other variables may be used in the equation to further evaluate the quality of a Subject.

Quality(Q)=(S_{Total}>=S_{Avg})+(Q_{Avg}>1)

Therefore, the Quality (Q) of a Subject will range from “0” to “2”

| Calculated Quality | Assessment | Quality Indicator |
|---|---|---|
| Q = 0 | Poor | Rating/Score shown in red color |
| | | or with “thumbs down” icon |
| Q = 1 | Average | Rating/Score shown in yellow |
| | | color or with one “thumbs |
| | | up” icon |
| Q = 2 | Superior | Rating/Score shown in green |
| | | color or with two “thumbs up” icons |

Several descriptions and illustrations have been presented to aid in understanding the features of the present invention. One with skill in the art will realize that numerous changes and variations are possible without departing from the spirit of the invention. Each of these changes and variations are within the scope of the present invention.

I claim:

1. A method for calculating and displaying a score or rating and related quality indicator comprising the steps of:
receiving at least one rating or score;
receiving information about how said rating or score was determined;
combining said rating or score with said information to produce an associated quality measure for said rating;
displaying said rating on a display device or printed material along with its associated quality measure or based on its associated quality measure.

2. The method of claim 1 wherein said rating or score is derived from a plurality of ratings or scores.

3. The method of claim 1 wherein said rating or score results from a survey or other instrument wherein an individual or group of individuals can submit feedback.

4. The method of claim 1 wherein said calculated rating or score is of a person, service, event, place or thing.

5. The method of claim 1 wherein said information includes at least one of product category, service category, sample sizes, demographics, sample gender composition, rater's age groups, level of prior participation, purchases, education level, communication address or unique personal identifier.

6. The method of claim 1 wherein said associated quality measure is displayed or printed using color.

7. The method of claim 1 wherein said associated quality measure is outputted on a display device or printed material using one or more icons.

8. The method of claim 1 wherein the rating or score is sorted or filtered based on a calculated quality measure.

9. A system for computing and outputting scores or ratings and associated visual quality indicators comprising:
a computation engine combining ratings or scores with input information to produce calculated ratings and associated quality values for said final ratings;
an output comprising a display device or printed material, wherein said display device or printed material presents said final associated quality values as visual quality indicators.

10. The system of claim 9 wherein said visual quality indicators are colors.

11. The system of claim 9 wherein said visual quality indicators are icons.

12. The system of claim 9 wherein said computation engine uses information about said ratings or scores to produce said associated quality values.

13. The system of claim 9 wherein said calculated ratings or quality values relate to a person, service, event, place or thing.

14. The system of claim 9 wherein said input information includes at least one of product category, service category, sample sizes, demographics, sample gender composition, rater's age groups, level of prior participation, purchases, education level, communication address or unique personal identifier.

15. A method for calculating and displaying a score or rating and related quality indicator on a display device or hardcopy comprising the steps of:
receiving a plurality of ratings or scores;
combining said ratings and scores to produce a final rating or score;
receiving information about how said ratings or scores were determined, wherein said information contains at least one of product category, service category, sample sizes, demographics, sample gender composition, rater's age groups, level of prior participation, purchases, education level, communication address or unique personal identifier;
combining said plurality of ratings or scores with said information to produce an associated quality measure for said rating;
displaying or printing said rating along with its associated quality measure or based on its associated quality measure.

16. The system of claim 15 wherein said final rating or quality measure relates to a person, service, event, place or thing.

17. The method of claim 15 wherein said associated quality measure is displayed or printed using color.

18. The method of claim 15 wherein said associated quality measure is outputted on a display device or printed material using one or more icons.
